(19) United States
(12) Patent Application Publication
(10) Pub. No.: US 2008/0316190 A1
(43) Pub. Date: Dec. 25, 2008

(54) Video Outputting Apparatus and Mounting Method

(75) Inventor: Tomoaki OKABE, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Osaka (JP)

(21) Appl. No.: 12/099,558

(22) Filed: Apr. 8, 2008

(30) Foreign Application Priority Data
Apr. 13, 2007 (JP) 2007-106305

(51) Int. Cl. G09G 5/00

(52) U.S. Cl. 345/204

(57) ABSTRACT

Disclosed is a video outputting apparatus including: a first display controlling section; and a second display controlling section for displaying predetermined image information during a period from a time when a power source is turned on to a time when the video information is displayed, wherein: the second display controlling section includes a reference clock generating circuit, a nonvolatile memory, and a controlling circuit including a plurality of external terminals for setting display setting information; the display setting information is set by a combination of setting of the plurality of external terminals; and the controlling circuit allows the displaying section to display the predetermined image information stored in the nonvolatile memory on a basis of the display setting information set by the plurality of external terminals in accordance with the generated reference clock signal.

### BACKGROUND OF THE INVENTION

1. Field of the Invention

The present invention relates to a video outputting apparatus and a mounting method.

2. Description of Related Art

Conventional video outputting apparatus to output the content input from connected reproducing apparatus, such as digital versatile disk (DVD) players, and video information, such as television broadcasting programs input from connected tuners, are configured to allow their displaying sections to display predetermined image information for the purpose of suppressing users' feeling of uneasiness during periods from the times when their power sources are turned on to the times when it becomes possible to display the video information.

To put it concretely, for example, the digital broadcasting receiving apparatus was proposed that continued to output the still image data stored in the memory thereof until synchronization was recovered when a loss of synchronization (abnormal reception) had been detected after the turning-on of the power source thereof (see, for example, Japanese Patent Application Laid-Open Publication No. Hei 07-322241).

Moreover, for example, the recording and reproducing apparatus integrated type television receiver was proposed that performed the initialization of the recording and reproducing section thereof when the power source thereof was turned on and was performing the on-screen display of a message indicating the performance of the initialization in the displaying section thereof during the period in which the initialization was being performed (see, for example, Japanese Patent Application Laid-Open Publication No. 2006-135853).

Moreover, for example, the digital broadcasting receiving apparatus was proposed that displayed an electronic program guide (EPG) until the start-up of the system thereof was completed (see, for example, Japanese Patent Application Laid-Open Publication No. 2006-303883).

Now, in each of the aforesaid video outputting apparatus disclosed in the Japanese Patent Application Laid-Open Publications, it is necessary for the central processing unit (CPU) thereof, which controls the whole video outputting apparatus, to obtain the display settings (such as the resolution of the displaying screen of the displaying section) of the displaying section of the apparatus to set the obtained display settings in the controlling circuit of the apparatus or to set the display settings of the displaying section into the controlling circuit in advance in order that the controlling circuit, which allows the displaying section to display the predetermined image information during the period from the time when the power source of the apparatus is turned on to the time when the video information is displayed, may display the image information suitable for the display settings of the displaying section.

However, if the CPU obtains the display settings of the displaying section to set the obtained display settings into the controlling circuit, then the image information is not displayed until the CPU starts up. Consequently, the video outputting apparatus have the problems of insufficient solutions of the problem in which the users feel uneasiness and the like.

Moreover, if the display settings of the displaying sections are previously set in the controlling circuits, then the controlling circuits must be produced according to the kinds of the displaying sections because the displaying settings are different from one another according to the kinds of the displaying sections. Consequently, the problem of the high component costs of the apparatus exists.

### SUMMARY OF THE INVENTION

It is an object of the present invention to provide an video outputting apparatus that can deal with various displaying sections having different display settings from one another and that is provided with a controlling circuit to allow the displaying sections to be displaying predetermined image information during the period from the time immediately after the turning-on of the power source thereof to the time when video information is displayed, and a mounting method of the controlling circuit onto the video outputting apparatus.

According to a first aspect of the invention, a video outputting apparatus to output video information, includes: a first display controlling section to allow a displaying section to display the video information; and a second display controlling section to allow the displaying section to display predetermined image information during a period from a time when a power source of the video outputting apparatus is turned on to a time when the video information is displayed in the displaying section by the first display controlling section, wherein: the second display controlling section includes a reference clock generating circuit to generate a reference clock signal when the power source of the video outputting apparatus is turned on, a nonvolatile memory to store the predetermined image information, and a controlling circuit including a plurality of external terminals for setting display setting information pertaining to a display setting of the displaying section; the display setting information is set by a combination of setting of the plurality of external terminals connected to a substrate of the video outputting apparatus; and the controlling circuit allows the displaying section to display the predetermined image information stored in the nonvolatile memory on a basis of the display setting information set by the plurality of external terminals in accordance with the reference clock signal generated by the reference clock generating circuit.

According to a second aspect of the invention, a video outputting apparatus to output video information includes: a first display controlling section to allow a displaying section to display the video information; and a second display controlling section to allow the displaying section to display predetermined image information during a period from a time when a power source of the video outputting apparatus is turned on to a time when the video information is displayed in the displaying section by the first display controlling section, wherein: the second display controlling section includes a reference clock generating circuit to generate a reference clock signal when the power source of the video outputting apparatus is turned on, a nonvolatile memory stores a plurality of pieces of image information, a controlling circuit provided with a plurality of external terminals for setting display setting information pertaining to a display setting of the displaying section, the display setting information including resolution information pertaining to horizontal resolution and vertical resolution of a displaying screen of the displaying section, positional information pertaining to a position in the displaying screen of the displaying section where the predetermined image information is displayed, and identification information for identifying the predetermined image information to be displayed in the displaying section among the plurality of pieces of image information stored in the nonvolatile memory, a horizontal counter to count a number of horizontal pixels in accordance with the reference clock signal generated by the reference clock generating circuit, the horizontal counter being reset when a counted value reaches a value of the horizontal resolution included in the resolution information, and a vertical counter to count a number of vertical pixels each time the horizontal counter is reset, the vertical counter being reset when a counted value reaches a value of the vertical resolution included in the resolution information; the display setting information is set by a combination of setting of the plurality of external terminals connected to a substrate of the video outputting apparatus; the controlling circuit obtains the predetermined image information to be displayed in the displaying section by one pixel a time among the plurality of pieces of image information stored in the nonvolatile memory on a basis of the identification information at obtaining timing based on the positional information in synchronization with the horizontal counter, and allows the displaying section to refresh displaying the obtained predetermined image information each time the vertical counter is reset; the video outputting apparatus is provided with a storage controlling section to allow the nonvolatile memory to store logo information pertaining to the video information displayed in the displaying section by the first display controlling section at a time the power source of the video outputting apparatus is turned off; and the second display controlling section allows the displaying section to display the logo information stored in the nonvolatile memory together with the predetermined image information stored in the nonvolatile memory during the period from the time when the power source of the video outputting apparatus is turned on to the time when the video information is displayed in the displaying section by the first display controlling section.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a diagram showing the functional configuration of a video outputting apparatus according to the present invention;

FIG. 2 is a view showing a displaying screen of a displaying section in which screen predetermined image information and logo information are displayed;

FIG. 3 is a flowchart for illustrating a mounting method of a controlling circuit onto the video outputting apparatus; and

FIG. 4 is a flowchart for illustrating the processing pertaining to the outputting of image information and video information by the video outputting apparatus.

### DETAILED DESCRIPTION OF THE PREFERRED EMBODIMENTS

In the following, the best modes for implementing the present invention will be described in detail with reference to the attached drawings. Incidentally, the scope of the invention is not limited to the shown examples.

### <Configuration of Video Outputting Apparatus>

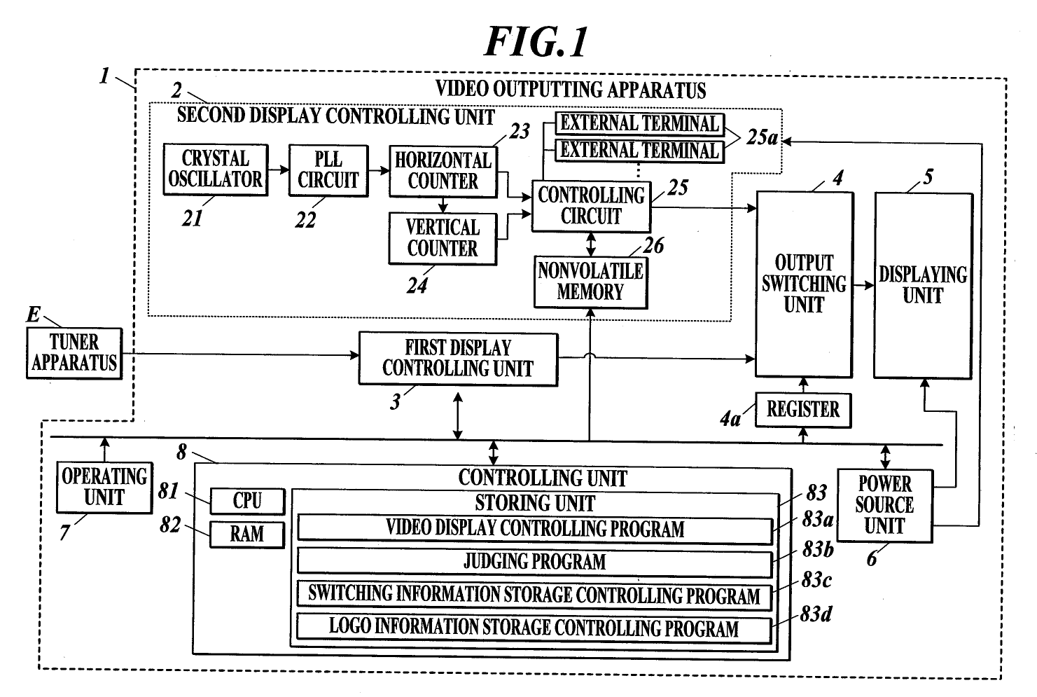

A video outputting apparatus 1 is connected to, for example, a tuner apparatus E to receive a television broadcasting signal and to input the video information based on the television broadcasting signal into the video outputting apparatus 1 through a signal processing section (not shown), as shown in FIG. 1. The video outputting apparatus 1 outputs the video information input from the tuner apparatus E through the signal processing section (not shown).

Now, the signal processing section (not shown) performs predetermined processing to a television broadcasting signal input from the tuner apparatus E to separate video data, audio data, and the like, from the television broadcasting signal. The signal processing section decodes the video data to output the decoded video data to the video outputting apparatus 1, and decodes the audio data to output the decoded audio data to an audio outputting apparatus (not shown).

Incidentally, the video outputting apparatus 1 may be integrally configured with the audio outputting apparatus (not shown).

To put it concretely, the video outputting apparatus 1 is composed of, for example, a second display controlling unit 2, a first display controlling unit 3, an output switching unit 4, a register 4a, a displaying unit 5, a power source unit 6, an operating unit 7, and a controlling unit 8, as shown in FIG. 1.

The second display controlling unit 2, as a second display controlling section, allows the displaying unit 5 to display, for example, logo information stored in a nonvolatile memory 26 together with predetermined image information, stored in the nonvolatile memory 26, for a period from the time when the power source of the video outputting apparatus 1 is turned on to the time when the video information is displayed in the displaying unit 5 by the first display controlling unit 3.

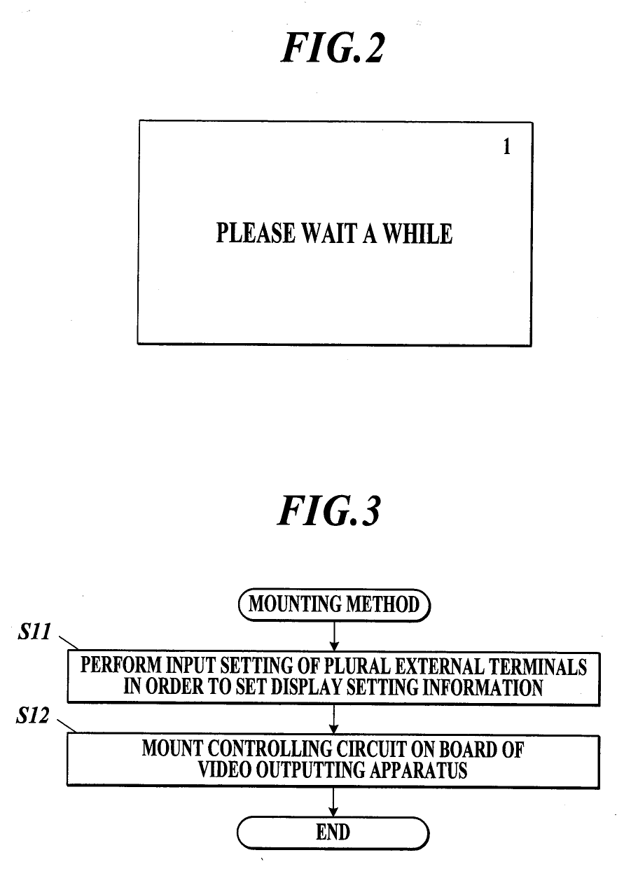

For example, the displaying screen of the displaying unit 5, in which the predetermined image information and the logo information are displayed, is shown in FIG. 2 here.

To put it concretely, the predetermined image information is the information pertaining to a message that the power source is turned on and the processing to display video information is now being performed, for example, as the expression “Please wait a while” displayed in the center of the displaying screen shown in FIG. 2.

Moreover, the logo information is the information pertaining to, for example, the channel number of the video information based on a television broadcasting signal to be input from the tuner apparatus E, which television broadcasting signal will be displayed in the displaying unit 5 from now on, as the numeral “1” displayed at an upper right position in the displaying screen shown in FIG. 2.

To put it concretely, the second display controlling unit 2 is composed of, for example, a crystal oscillator 21, a phase locked loop (PLL) circuit 22, a horizontal counter 23, a vertical counter 24, a controlling circuit 25 including a plurality of external terminals 25a, and the nonvolatile memory 26, as shown in FIG. 1.

The crystal oscillator 21 oscillates, for example, when the power source of the video outputting apparatus 1 is turned on.

The PLL circuit 22 generates a reference clock signal on the basis of, for example, the oscillation of the crystal oscillator 21.

A reference clock generating circuit to generate the reference clock signal when the power source of the video outputting apparatus 1 is turned on is configured of the crystal oscillator 21, the PLL circuit 22, and the like, here.

The horizontal counter 23 counts, for example, the number of horizontal pixels on the basis of the reference clock signal generated by the crystal oscillator 21 and the PLL circuit 22, and the horizontal counter 23 resets the counted value thereof when the counted value reaches the value of the horizontal resolution included in resolution information (described below).

The vertical counter 24 counts, for example, the number of vertical pixels each time the horizontal counter 23 is reset, and the vertical counter 24 is reset when the counted value thereof reaches the value of the vertical resolution included in the resolution information (described below).

The controlling circuit 25 includes, for example, a plurality of external terminals 25a for setting the display setting information pertaining to the display settings of the displaying unit 5, and allows the displaying unit 5 to display the predetermined image information and the logo information, which are stored in the nonvolatile memory 26, on the basis of the display setting information set by the plurality of external terminals 25a in accordance with the reference clock signal generated by the crystal oscillator 21 and the PLL circuit 22.

To put it concretely, each of the plurality of external terminals 25a is made of, for example, a dual in line package (DIP) switch capable of being switched between on and off, and the display setting information is set by, for example, a combination of the ons and the offs of the plurality of external terminals 25a connected to the substrate (not shown) of the video outputting apparatus 1.

The display setting information includes, for example, the resolution information, image position information (positional information), logo position information, and identification information.

The resolution information is, for example, the information pertaining to the horizontal resolution and the vertical resolution of the displaying screen of the displaying unit 5.

That is, the video outputting apparatus 1 is adapted to be able to set the resolution information suitable for the displaying screen of the displaying unit 5 by means of, for example, the combinations of the plurality of ons and offs of the plurality of external terminals 25a for the resolution information as follows: there is a plurality of (for example two) external terminals 25a for the resolution information among the plurality of external terminals 25a; if a combination of setting of the plurality of external terminals 25a for the resolution information is, for example, “off and on,” then the horizontal resolution×the vertical resolution=1366×768 (wide XGA), and if, for example, “on and off,” then the horizontal resolution×the vertical resolution=1920×1080 (full HD).

The horizontal counter 23 is then reset, for example, when the counted value reaches the value of the horizontal resolution included in the set resolution information; the vertical counter 24 is reset when the counted value reaches the value of the vertical resolution included in the set resolution information; and the controlling circuit 25 obtains the predetermined image information by one pixel at a time from the nonvolatile memory 26 in synchronization with the horizontal counter 23, and outputs the obtained predetermined image information to the output switching unit 4 in order to allow the display unit 5 to display the predetermined image information each time the outputs vertical counter 24 is reset.

It is a matter of course that the number of the plurality of external terminals 25a for the resolution information is not limited to the two, but the number is arbitrary as long as the number makes it possible to express the resolution of the displaying unit 5 provided in the video outputting apparatus 1 capable of mounting the controlling circuit 25 thereon.

Moreover, the image position information is, for example, the information pertaining to the position in the displaying screen of the displaying unit 5 where the predetermined image information is displayed.

That is, the video outputting apparatus 1 is adapted to be able to set the desired image position information by means of, for example, the combinations of ons and offs of the plurality of external terminals 25a for the image position information as follows: there is a plurality of (for example two) external terminals 25a for the image position information among the external terminals 25a; if a combination of setting of the plurality of external terminals 25a for the image position information is, for example, “off and off,” then the image position is the center position in the displaying screen, and if, for example, “on and on,” then the image position is a lower right position in the displaying screen.

The controlling circuit 25 then obtains the predetermined image information from the nonvolatile memory 26, for example, at the obtaining timing based on the set image position information.

It is a matter of course that the number of the plurality of external terminals 25a for image position information is not limited to the two, but that the number is arbitrary as long as the number makes it possible to specify the position in the displaying screen where the predetermined image information is displayed.

Moreover, the logo position information is the information pertaining to, for example, the position in the displaying screen of the displaying unit 5 where the logo information is displayed.

That is, the video outputting apparatus 1 is adapted to be able to set the desired logo position information by means of, for example, the combinations of ons and offs of the plurality of external terminals 25a for the logo position information as follows: there is a plurality of (for example two) external terminals 25a for the logo position information among the plurality of external terminals 25a; if a combination of setting of the plurality of external terminals 25a for the logo position information is, for example, “off and off,” then the logo position is an upper right position in the displaying screen, and if, for example, “on and on,” then the logo position is an upper left position in the displaying screen.

The controlling circuit 25 then obtains the logo information from the nonvolatile memory 26, for example, at the obtaining timing based on the set logo position information.

It is a matter of course that the number of the plurality of external terminals 25a for the logo position information is not limited to the two, but that the number is arbitrary as long as the number makes it possible to specify the position in the displaying screen where the logo information is displayed.

Moreover, the identification information is, for example, the information for identifying the predetermined image information to be displayed in the displaying unit 5 among the plurality of pieces of image information stored in the nonvolatile memory 26.

That is, the video outputting apparatus 1 is adapted to be able to set the desired identification information by means of, for example, the combinations of ons and offs of the plurality of external terminals 25a for the identification information as follows: there is a plurality of (for example two) external terminals 25a for the identification information among the plurality of external terminals 25a; if a combination of setting of the plurality of external terminals 25a for the identification information is, for example, “off and on,” then the image information to be displayed is “image information B,” and if, for example, “on and on,” then the image information to be displayed is “image information D.”

The controlling circuit 25 then obtains, for example, the predetermined image information to be displayed in the displaying unit 5 among the plurality of pieces of image information stored in the nonvolatile memory 26 on the basis of the set identification information.

It is a matter of course that the number of the plurality of external terminals 25a for the identification information is not limited to the two, but that the number is arbitrary as long as the number makes it possible to identify each of the plurality of pieces of image information stored in the nonvolatile memory 26.

The nonvolatile memory 26 is, for example, a recording medium against which the reading, the writing, and the erasing of data can be performed.

To put it concretely, the nonvolatile memory 26 previously stores, for example, a plurality of pieces of image information to be displayed in the displaying unit 5.

Moreover, the nonvolatile memory 26 stores, for example, the logo information pertaining to the video information displayed in the displaying unit 5 by the first display controlling unit 3 when the power source of the video outputting apparatus 1 is turned off, in accordance with a control signal input from the controlling unit 8.

The first display controlling unit 3, as a first display controlling section, allows the displaying unit 5 to display, for example, the video information input from the tuner apparatus E through the signal processing section (not shown) in accordance with a control signal input from the controlling unit 8.

To put it concretely, the first display controlling unit 3 performs, for example, predetermined processing to the vide information input from the tuner apparatus E, and outputs the processed video information to the output switching unit 4.

The output switching unit 4 switches, for example, the information to be output to the displaying unit 5 to the predetermined image information and the logo information, which are input from the controlling circuit 25 and to the video information, which is input from the first display controlling unit 3, on the basis of the switching information stored in the register 4a.

The register 4a stores, for example, the switching information to allow the output switching unit 4 to switch the information to be output to the displaying unit 5 to the predetermined image information and the logo information, which are input from the controlling circuit 25, and to the video information, which is input from the first display controlling unit 3, on the basis of the control signal input from the controlling unit 8.

That is, the switching information includes the switching information for switching the information to be output to the displaying unit 5 to the predetermined image information and the logo information, which are input from the controlling circuit 25, and the switching information for switching the information to be output to the displaying unit 5 to the video information, which is input from the first display controlling unit 3.

The displaying unit 5 is, for example, liquid crystal display equipment, and, as a displaying section, outputs, for example, an image based on the image information and the logo information, which are input from the output switching unit 4, and the video based on the video information, which is input from the output switching unit 4.

The power source unit 6 is composed of, for example, a storage battery, and performs power distribution to each section of the video outputting apparatus 1 when the power source of the video outputting apparatus 1 is turned on.

The operating unit 7 is compose of, for example, operation buttons (not shown) provided on the external surface of the video outputting apparatus 1, a remote controller (not shown) for the video outputting apparatus 1, and a remote control receiving section (not shown) capable of communicating with the remote controller. For example, when the operating unit 7 is operated by the user, the operating unit 7 outputs various signals according to the operation to the controlling unit 8.

To put it concretely, the operating unit 7 is operated, for example, when the user turns on or off the power source of the video outputting apparatus 1.

The controlling unit 8 is composed of, for example, a central processing unit (CPU) 81, a random access memory (RAM) 82, and a storing unit 83, as shown in FIG. 1.

The CPU 81 performs, for example, various controlling operations in accordance with various processing programs for the video outputting apparatus 1, which programs are stored in the storing unit 83.

The RAM 82 includes, for example, a program storing region to expand the processing program to be executed by the CPU 81, a data storing region to store input data and processing results produced at the time of the execution of the processing program, and the like.

The storing unit 83 stores, for example, a system program capable of being executed in the video outputting apparatus 1, various processing programs capable of being executed on the system program, the data to be used at the time of the execution of these various processing programs, and the data of the processing results of the operation processing of the CPU 81. Incidentally, the programs are stored in the storing unit 83 in the forms of program codes that a computer can read.

To put it concretely, the storing unit 83 stores, for example, an video display controlling program 83a, a judging program 83b, a switching information storage controlling program 83c, and a logo information storage controlling program 83d, as shown in FIG. 1.

The video display controlling program 83a enables the CPU 81 to realize, for example, the function of inputting a control signal into the first display controlling unit 3 to allow the displaying unit 5 to display the video information input from the tuner apparatus E.

The judging program 83b enables the CPU 81 to realize, for example, the function of judging whether video information is in the state capable of being displayed in the displaying unit 5 by the first display controlling unit 3 or not.

The switching information storage controlling program 83c enables the CPU 81 to realize, for example, the function of allowing the register 4a to store switching information.

To put it concretely, for example, if the CPU 81, which has executed the judging program 83b, judges that video information is in the state capable of being displayed in the displaying unit 5 by the first display controlling unit 3, then the CPU 81 allows the register 4a to store the switching information for switching the information to be output to the displaying unit 5 to the video information to be input from the first display controlling unit 3.

Moreover, for example, if the CPU 81 is instructed to turn off the power source of the video outputting apparatus 1 by a user's operation of the operating unit 7, then the CPU 81 allows the register 4a to store the switching information for switching the information be output to the displaying unit 5 to the predetermined image information and the logo information, which are input from the controlling circuit 25.

Thereby, if the power source of the video outputting apparatus 1 is turned on after the turning-off of the power source of the video outputting apparatus 1, then the predetermined image information and the logo information, which have been stored in the nonvolatile memory 26, are led to be displayed in the displaying unit 5 during a period from the time when the power source of the video outputting apparatus 1 is turned on to the time when video information is displayed in the displaying unit 5 by the first display controlling unit 3.

The logo information storage controlling program 83d enables CPU 81 to realize, for example, the function of updating the logo information stored in the nonvolatile memory 26 by allowing the nonvolatile memory 26 to store the logo information pertaining to the video information displayed in the displaying unit 5 by the first display controlling unit 3 when the power source of the video outputting apparatus 1 is turned off.

The CPU 81 functions as a storage controlling section by executing this logo information storage controlling program 83d.

### <Mounting Method>

The mounting method of the controlling circuit 25 into the video outputting apparatus 1 is described with reference to the flowchart of FIG. 3.

Input setting is first performed to the plurality of external terminals 25a in order to set display setting information (Step S11).

The controlling circuit 25 is next mounted onto the substrate (not shown) of the video outputting apparatus 1 (Step S12).

That is, after the input setting has been performed to the plurality of external terminals 25a and desired display setting information has been set, the controlling circuit 25 is mounted into the video outputting apparatus 1.

### <Outputting Processing>

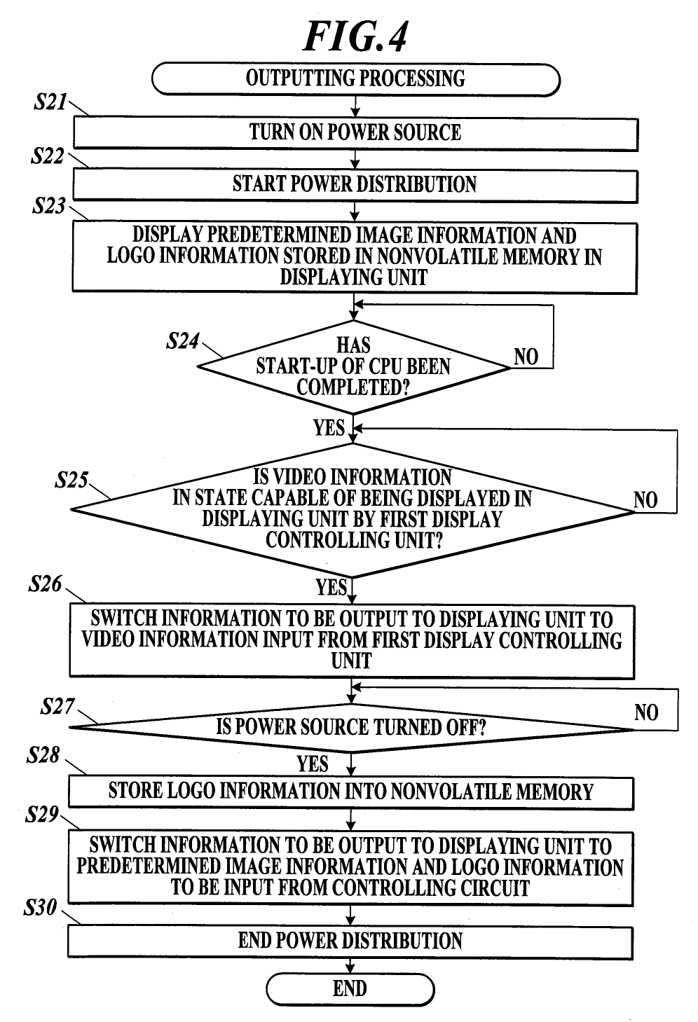

The processing pertaining to the outputting of the predetermined image information and the video information by the video outputting apparatus 1 is described with reference to the flowchart of FIG. 4.

When a user first operates the operating unit 7 to instruct to turn on the power source of the video outputting apparatus 1 (Step S21), the power source unit 6 starts the power distribution to each section of the video outputting apparatus 1 (Step S22).

The crystal oscillator 21 next oscillates in association with the start of the power distribution at Step S22, and consequently the predetermined image information and the logo information stored in the nonvolatile memory 26 is displayed in the displaying unit 5 (Step S23).

Next, until the start-up of the CPU 81, which controls the whole video outputting apparatus 1, has been completed, the processing at Step S24 is repeatedly performed.

Next, when the start-up of the CPU 81 is completed (Step S24; Yes), the CPU 81 executes the judging program 83b to judge whether video information is in the state capable of being displayed in the displaying section 5 by the first display controlling unit 3 or not (Step S25).

If the CPU 81 judges that the video information is not in the state capable of being displayed in the displaying unit 5 by the first display controlling unit 3 yet at Step S25 (Step S25; No), then the CPU 81 repeatedly performs the processing at Step S25.

On the other hand, if the CPU 81 judges that the video information is in the state capable of being displayed in the displaying unit 5 by the first display controlling unit 3 at Step S25 (Step S25; Yes), then the CPU 81 executes the switching information storage controlling program 83c to allow the register 4a to store the switching information for switching the information to be output to the displaying unit 5 to the video information to be input from the first display controlling unit 3, and to allow the output switching unit 4 to switch the information to be output to the displaying unit 5 to the video information to be input from the first display controlling unit 3 (Step S26).

The CPU 81 next judges whether the user has operated the operating unit 7 to instruct to turn off the power source of the video outputting apparatus 1 or not (Step S27).

If the CPU 81 judges that the turning-off of the power source of the video outputting apparatus 1 has not been instructed at Step S27 (Step S27; No), then the CPU 81 repeatedly performs the processing at Step S27.

On the other hand, if the CPU 81 judges that the turning-off the power source of the video outputting apparatus 1 has been instructed at Step S27 (Step S27; Yes), then the CPU 81 executes the logo information storage controlling program 83d to allow the first display controlling unit 3 to store the logo information pertaining to the video information displayed in the displaying unit 5 into the nonvolatile memory 26 (Step S28).

The CPU 81 next executes the switching information storage controlling program 83c to allow the register 4a to store the switching information for switching the information to be output to the displaying unit 5 to the predetermined image information and the logo information, which are input from the controlling circuit 25, and allows the output switching unit 4 to switch the information to be output to the displaying unit 5 to the predetermined image information and the logo information, which are input from the controlling circuit 25 (Step S29). Then, the CPU 81 allows the power source unit 6 to end the power distribution to each section of the video outputting apparatus 1 (Step S30), and ends the present processing.

According to the video outputting apparatus 1 of the present invention described above, video information can be displayed in the displaying unit 5 by the first display controlling unit 3, and the predetermined image information can be displayed in the displaying unit 5 during the period from the time when the power source of the video outputting apparatus 1 is turned on to the time when the video information is displayed in the displaying unit 5 by the first display controlling unit 3, by the second display controlling unit 2. To put it concretely, the second display controlling unit 2 is provided with the crystal oscillator 21 and the PLL circuit 22 to generate the reference clock signal when the power source of the video outputting apparatus 1 is turned on, the nonvolatile memory 26 to store the predetermined image information, and the controlling circuit 25 to include the plurality of external terminals 25a for setting the display setting information pertaining to the display settings of the displaying unit 5, and the controlling circuit 25 can allow the displaying unit 5 to display the predetermined image information stored in the nonvolatile memory 26 on the basis of the display setting information set by the plurality of external terminals 25a in accordance with the reference clock signal generated by the crystal oscillator 21 and the PLL circuit 22.

Consequently, the controlling circuit 25 provided in the second display controlling unit 2 can allow the displaying unit 5 to display the previously stored predetermined image information on the basis of the previously set display setting information in accordance with the reference clock signal, which is generated when the power source of the video outputting apparatus 1 is turned on, even if the start-up of the CPU 81, which controls the whole video outputting apparatus 1, is not completed yet. That is, the controlling circuit 25 can allow the displaying unit 5 to display the predetermined image information during the period form the time immediately after the turning-on of the power source of the video outputting apparatus 1 to the time when the video information is displayed.

Moreover, because the display setting information is set by the combination of setting of the plurality of external terminals 25a connected to the substrate (not shown) of the video outputting apparatus 1, the controlling circuit 25 can deal with various displaying sections 5 having different display settings from one another.

Moreover, according to the video outputting apparatus 1, the display setting information includes the resolution information pertaining to the horizontal resolution and the vertical resolution of the displaying screen of the displaying unit 5; the second display controlling unit 2 is provided with the horizontal counter 23, which counts the number of horizontal pixels in accordance with the reference clock signal generated by the crystal oscillator 21 and the PLL circuit 22 and is reset when the counted value reaches the value of the horizontal resolution included in the resolution information, and the vertical counter 24, which counts the number of vertical pixels each time the horizontal counter 23 is reset and is reset when the counted value reaches the value of the vertical resolution included in the resolution information; and the controlling circuit 25 obtains the predetermined image information by one pixel at a time from the nonvolatile memory 26 in synchronization with the horizontal counter 23, and can allow the displaying unit 5 to refresh displaying the obtained predetermined image information each time the vertical counter 24 is reset.

Consequently, the controlling circuit 25 can deal with various displaying sections 5 having different resolution of the display screens from one another by itself, and can display the predetermined image information suitable for the displaying screens of the displaying sections 5 even if the CPU 81, which controls the whole video outputting apparatus 1, does not set the resolution of the displaying screen of the displaying sections 5.

Moreover, according to the video outputting apparatus 1, the display setting information includes the image position information pertaining to the position in the displaying screen of the displaying unit 5 where the predetermined image information is displayed, and the controlling circuit 25 can obtain the predetermined image information from the nonvolatile memory 26 at the obtaining timing based on the image position information.

Consequently, the controlling circuit 25 can deal with various demands for displaying the predetermined image information at desired positions in the displaying screens by itself, and the controlling section 25 can allow the displaying sections 5 to display the predetermined image information at the desired positions in the displaying screens of the displaying sections 5 even if the CPU 81, which controls the whole video outputting apparatus 1, does not set the positions in the displaying screens of the displaying sections 5 whereas the predetermined image information is displayed.

Moreover, according to the video outputting apparatus 1, the nonvolatile memory 26 stores the plurality of pieces of image information, and the display setting information includes the identification information for identifying the predetermined image information to be displayed in the displaying unit 5 among the plurality of pieces of image information stored in the nonvolatile memory 26; and the controlling circuit 25 can obtain the predetermined image information to be displayed in the displaying unit 5 among the plurality of pieces of image information stored in the nonvolatile memory 26 on the basis of the identification information.

Consequently, the controlling circuit 25 can deal with various demands for allowing the image information to be displayed the desired predetermined image information by itself, and the controlling section 25 can display the desired predetermined image information even if the CPU 81, which controls the whole video outputting apparatus 1, does not set the predetermined image information to be displayed.

Moreover, according to the video outputting apparatus 1, the apparatus is provided with the CPU 81, which has executed the logo information storage controlling program 83d to allow the nonvolatile memory 26 to store the logo information pertaining to the video information displayed in the displaying unit 5 by the first display controlling unit 3 when the power source of the video outputting apparatus 1 is turned off; and the second display controlling unit 2 can allow the displaying unit 5 to display the logo information stored in the nonvolatile memory 26 together with the predetermined image information stored in the nonvolatile memory 26 during the period from the time when the power source of the video outputting apparatus 1 is turned on to the time when video information is displayed in the displaying unit 5 by the first display controlling unit 3.

Consequently, because the second display controlling unit 2 can display the logo information pertaining to the video information displayed in the displaying unit 5 at the time of the turning-off of the power source of the video outputting apparatus 1 immediately before the turning-on of the power source, that is, the logo information pertaining to the video information to be displayed from now on, during the period from the time immediately after the turning-on of the power source to the time when the video information is displayed, the usability of the video outputting apparatus 1 is good.

Moreover, according to the mounting method of the controlling circuit 25 into the video outputting apparatus 1, input settings to the plurality of external terminals 25a are performed in order to set the display setting information, and then the controlling circuit 25 is mounted onto the substrate (not shown) of the video outputting apparatus 1.

Consequently, the controlling circuit 25 can deal with various displaying sections 5 having different display settings from one another.

Incidentally, the present invention is not limited to the embodiment described above, and can be suitably changed from the embodiment without departing from the scope and the spirit thereof.

The external apparatus to be connected to the video outputting apparatus 1 is not limited to the tuner apparatus E, but any of the audio visual (AV) equipment capable of inputting video information into the video outputting apparatus 1, such as a DVD player, a video recorder, a personal video recorder (PVR), a set top box (STB), and an audio apparatus, can be used.

Moreover, the external apparatus connected to the video outputting apparatus 1 is not limited to one, but may be plural.

If the video information displayed in the displaying unit 5 by the first display controlling unit 3 at the time when the power source of the video outputting apparatus 1 is turned off is the video information input from the external apparatus other than the tuner apparatus E here, then the logo information pertaining to the video information is the information pertaining to the switching of the external input, such as “video 1” and “video 2.”

The predetermined image information displayed in the displaying unit 5 is not only the information pertaining to the message indicating that the processing to display the video information is now being performed after the turning-on of the power source, but may also include, for example, the information pertaining to a mark indicating the maker of the video outputting apparatus 1.

The information included in the display setting information is not limited to the resolution information, the image position information, the logo position information, and the identification information, but may be arbitrary as long as the information pertains to the display settings of the displaying unit 5. For example, the information may be the background color information pertaining to the background color of video information and the like.

According to the first aspect of the preferred embodiments of the present invention, there is provided a video outputting apparatus to output video information, including: a first display controlling section to allow a displaying section to display the video information; and a second display controlling section to allow the displaying section to display predetermined image information during a period from a time when a power source of the video outputting apparatus is turned on to a time when the video information is displayed in the displaying section by the first display controlling section, wherein: the second display controlling section includes a reference clock generating circuit to generate a reference clock signal when the power source of the video outputting apparatus is turned on, a nonvolatile memory to store the predetermined image information, and a controlling circuit including a plurality of external terminals for setting display setting information pertaining to a display setting of the displaying section; the display setting information is set by a combination of setting of the plurality of external terminals connected to a substrate of the video outputting apparatus; and the controlling circuit allows the displaying section to display the predetermined image information stored in the nonvolatile memory on a basis of the display setting information set by the plurality of external terminals in accordance with the reference clock signal generated by the reference clock generating circuit.

Preferably, the display setting information includes resolution information pertaining to horizontal resolution and vertical resolution of a displaying screen of the displaying section; the second display controlling section includes a horizontal counter to count a number of horizontal pixels in accordance with the reference clock signal generated by the reference clock generating circuit, the horizontal counter being reset when a counted value reaches a value of the horizontal resolution included in the resolution information, and a vertical counter to count a number of vertical pixels each time the horizontal counter is reset, the vertical counter being reset when a counted value reaches a value of the vertical resolution included in the resolution information; and the controlling circuit obtains the predetermined image information by one pixel at a time from the nonvolatile memory in synchronization with the horizontal counter, and allows the displaying section to refresh displaying the obtained predetermined image information each time the vertical counter is reset.

Preferably, the display setting information includes positional information pertaining to a position in a displaying screen of the displaying section where the predetermined image information is displayed, and the controlling circuit obtains the predetermined image information from the nonvolatile memory at obtaining timing based on the positional information.

Preferably, the nonvolatile memory stores a plurality of pieces of image information; the display setting information includes identification information for identifying the predetermined image information to be displayed in the displaying section among the plurality of pieces of image information stored in the nonvolatile memory; and the controlling circuit obtains the predetermined image information to be displayed in the displaying section among the plurality of pieces of image information stored in the nonvolatile memory on a basis of the identification information.

Preferably, the video outputting apparatus further includes a storage controlling section to allow the nonvolatile memory to store logo information pertaining to the video information displayed in the displaying section by the first display controlling section at a time the power source of the video outputting apparatus is turned off, wherein the second display controlling section allows the displaying section to display the logo information stored in the nonvolatile memory together with the predetermined image information stored in the nonvolatile memory during the period from the time when the power source of the video outputting apparatus is turned on to the time when the video information is displayed in the displaying section by the first display controlling section.

According to the second aspect of the preferred embodiments of the present invention, there is provided a video outputting apparatus to output video information including: a first display controlling section to allow a displaying section to display the video information; and a second display controlling section to allow the displaying section to display predetermined image information during a period from a time when a power source of the video outputting apparatus is turned on to a time when the video information is displayed in the displaying section by the first display controlling section, wherein: the second display controlling section includes a reference clock generating circuit to generate a reference clock signal when the power source of the video outputting apparatus is turned on, a nonvolatile memory stores a plurality of pieces of image information, a controlling circuit provided with a plurality of external terminals for setting display setting information pertaining to a display setting of the displaying section, the display setting information including resolution information pertaining to horizontal resolution and vertical resolution of a displaying screen of the displaying section, positional information pertaining to a position in the displaying screen of the displaying section where the predetermined image information is displayed, and identification information for identifying the predetermined image information to be displayed in the displaying section among the plurality of pieces of image information stored in the nonvolatile memory, a horizontal counter to count a number of horizontal pixels in accordance with the reference clock signal generated by the reference clock generating circuit, the horizontal counter being reset when a counted value reaches a value of the horizontal resolution included in the resolution information, and a vertical counter to count a number of vertical pixels each time the horizontal counter is reset, the vertical counter being reset when a counted value reaches a value of the vertical resolution included in the resolution information; the display setting information is set by a combination of setting of the plurality of external terminals connected to a substrate of the video outputting apparatus; the controlling circuit obtains the predetermined image information to be displayed in the displaying section by one pixel a time among the plurality of pieces of image information stored in the nonvolatile memory on a basis of the identification information at obtaining timing based on the positional information in synchronization with the horizontal counter, and allows the displaying section to refresh displaying the obtained predetermined image information each time the vertical counter is reset; the video outputting apparatus is provided with a storage controlling section to allow the nonvolatile memory to store logo information pertaining to the video information displayed in the displaying section by the first display controlling section at a time the power source of the video outputting apparatus is turned off; and the second display controlling section allows the displaying section to display the logo information stored in the nonvolatile memory together with the predetermined image information stored in the nonvolatile memory during the period from the time when the power source of the video outputting apparatus is turned on to the time when the video information is displayed in the displaying section by the first display controlling section.

Preferably, a mounting method of the controlling circuit into the video outputting apparatus including the steps of: performing input setting to the plurality of external terminals for setting the display setting information; and mounting the controlling circuit onto a substrate of the video outputting apparatus.

According to the present invention, the second display controlling section can allow the displaying section to display the predetermined image information during the period from the time when the power source of the video outputting apparatus is turned on to the time when video information is displayed in the displaying section by the first display controlling section. To put it concretely, the second display controlling section is provided with the reference clock generating circuit to generate the reference clock signal when the power source of the video outputting apparatus is turned on, the nonvolatile memory to store the predetermined image information, and the controlling circuit including the plurality of external terminals for setting the display setting information pertaining to the display settings of the displaying section. The controlling circuit can allow the displaying section to display the predetermined image information stored in the nonvolatile memory on the basis of the display setting information set by the plurality of external terminals in accordance with the reference clock generated by the reference clock generating circuit.

Consequently, the controlling circuit provided in the second display controlling section can display the previously stored predetermined image information in the displaying section on the basis of the previously set display setting information in accordance with the reference clock signal, which is generated when the power source of the video outputting apparatus is turned on, even if the start-up of the CPU, which controls the whole video outputting apparatus, is not completed. That is, the controlling circuit can allow the displaying section to display the predetermined image information during the period from the time immediately after the turning-on of the power source of the video outputting apparatus to the time when video information is displayed.

Moreover, because the display setting information is set by the combination of setting of the plurality of external terminals connected to the substrate of the video outputting apparatus, the controlling circuit can deal with the various displaying sections having different display settings from one another.

The entire disclosure of Japanese Patent Application No. 2007-106305 filed on Apr. 13, 2007 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A video outputting apparatus to output video information, comprising:
a first display controlling section to allow a displaying section to display the video information; and
a second display controlling section to allow the displaying section to display predetermined image information during a period from a time when a power source of the video outputting apparatus is turned on to a time when the video information is displayed in the displaying section by the first display controlling section, wherein:
the second display controlling section includes
a reference clock generating circuit to generate a reference clock signal when the power source of the video outputting apparatus is turned on,
a nonvolatile memory to store the predetermined image information, and
a controlling circuit including a plurality of external terminals for setting display setting information pertaining to a display setting of the displaying section;
the display setting information is set by a combination of setting of the plurality of external terminals connected to a substrate of the video outputting apparatus; and
the controlling circuit allows the displaying section to display the predetermined image information stored in the nonvolatile memory on a basis of the display setting information set by the plurality of external terminals in accordance with the reference clock signal generated by the reference clock generating circuit.

2. The video outputting apparatus according to claim 1, wherein
the display setting information includes resolution information pertaining to horizontal resolution and vertical resolution of a displaying screen of the displaying section;
the second display controlling section includes
a horizontal counter to count a number of horizontal pixels in accordance with the reference clock signal generated by the reference clock generating circuit, the horizontal counter being reset when a counted value reaches a value of the horizontal resolution included in the resolution information, and
a vertical counter to count a number of vertical pixels each time the horizontal counter is reset, the vertical counter being reset when a counted value reaches a value of the vertical resolution included in the resolution information; and
the controlling circuit obtains the predetermined image information by one pixel at a time from the nonvolatile memory in synchronization with the horizontal counter, and allows the displaying section to refresh displaying the obtained predetermined image information each time the vertical counter is reset.

3. The video outputting apparatus according to claim 1, wherein:
the display setting information includes positional information pertaining to a position in a displaying screen of the displaying section where the predetermined image information is displayed, and
the controlling circuit obtains the predetermined image information from the nonvolatile memory at obtaining timing based on the positional information.

4. The video outputting apparatus according to claim 1, wherein:
the nonvolatile memory stores a plurality of pieces of image information;
the display setting information includes identification information for identifying the predetermined image information to be displayed in the displaying section among the plurality of pieces of image information stored in the nonvolatile memory; and
the controlling circuit obtains the predetermined image information to be displayed in the displaying section among the plurality of pieces of image information stored in the nonvolatile memory on a basis of the identification information.

5. The video outputting apparatus according to claim 1, further comprising a storage controlling section to allow the nonvolatile memory to store logo information pertaining to the video information displayed in the displaying section by the first display controlling section at a time the power source of the video outputting apparatus is turned off, wherein
the second display controlling section allows the displaying section to display the logo information stored in the nonvolatile memory together with the predetermined image information stored in the nonvolatile memory during the period from the time when the power source of the video outputting apparatus is turned on to the time when the video information is displayed in the displaying section by the first display controlling section.

6. A video outputting apparatus to output video information, comprising:
a first display controlling section to allow a displaying section to display the video information; and
a second display controlling section to allow the displaying section to display predetermined image information during a period from a time when a power source of the video outputting apparatus is turned on to a time when the video information is displayed in the displaying section by the first display controlling section, wherein:
the second display controlling section includes
a reference clock generating circuit to generate a reference clock signal when the power source of the video outputting apparatus is turned on,
a nonvolatile memory stores a plurality of pieces of image information,
a controlling circuit provided with a plurality of external terminals for setting display setting information pertaining to a display setting of the displaying section, the display setting information including resolution information pertaining to horizontal resolution and vertical resolution of a displaying screen of the displaying section, positional information pertaining to a position in the displaying screen of the displaying section where the predetermined image information is displayed, and identification information for identifying the predetermined image information to be displayed in the displaying section among the plurality of pieces of image information stored in the nonvolatile memory,
a horizontal counter to count a number of horizontal pixels in accordance with the reference clock signal generated by the reference clock generating circuit, the horizontal counter being reset when a counted value reaches a value of the horizontal resolution included in the resolution information, and
a vertical counter to count a number of vertical pixels each time the horizontal counter is reset, the vertical counter being reset when a counted value reaches a value of the vertical resolution included in the resolution information;
the display setting information is set by a combination of setting of the plurality of external terminals connected to a substrate of the video outputting apparatus;
the controlling circuit obtains the predetermined image information to be displayed in the displaying section by one pixel a time among the plurality of pieces of image information stored in the nonvolatile memory on a basis of the identification information at obtaining timing based on the positional information in synchronization with the horizontal counter, and allows the displaying section to refresh displaying the obtained predetermined image information each time the vertical counter is reset;
the video outputting apparatus is provided with a storage controlling section to allow the nonvolatile memory to store logo information pertaining to the video information displayed in the displaying section by the first display controlling section at a time the power source of the video outputting apparatus is turned off; and
the second display controlling section allows the displaying section to display the logo information stored in the nonvolatile memory together with the predetermined image information stored in the nonvolatile memory during the period from the time when the power source of the video outputting apparatus is turned on to the time when the video information is displayed in the displaying section by the first display controlling section.

7. A mounting method of the controlling circuit into the video outputting apparatus according to claim 1, the method comprising the steps of:
performing input setting to the plurality of external terminals for setting the display setting information; and
mounting the controlling circuit onto a substrate of the video outputting apparatus.
